(19) United States
(12) Patent Application Publication
(10) Pub. No.: US 2003/0219636 A1
(43) Pub. Date: Nov. 27, 2003

(54) Method and apparatus for supplying an oxidant stream to the cathode of a fuel cell

(75) Inventor: Lars Kaufmann, (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Power Systems AG, Kirchheim - Nabern (DE)

(21) Appl. No.: 10/352,771

(22) Filed: Jan. 27, 2003

(30) Foreign Application Priority Data
Jan. 26, 2002 (DE) 10203029.4

(51) Int. Cl. H01M 8/04

(52) U.S. Cl. 429/17; 429/34

(57) ABSTRACT

Methods and apparatus for supplying an oxidant stream, in particular air, to a cathode of a fuel cell, include an oxidant supply device and a return line to recirculate part of the oxidant discharged from the cathode into the oxidant supplied to the cathode. A throttle device is located in the return line, which is connected upstream of the oxidant supply device.

### CROSS-REFERENCE TO RELATED APPLICATION

This application claims priority under 35 U.S.C. §119 to German Application No. 10203029.4, filed Jan. 26, 2002, which priority application is incorporated herein by reference in its entirety.

### BACKGROUND OF THE INVENTION

WO 00/63993 discloses a power-network-independent zero-emission portable power supply device. This power supply device employs a fuel cell, in particular a PEM fuel cell, to generate the required electrical power. The described fuel cell design includes the recirculation of air from the cathode outlet to the cathode inlet. A pump draws in and compresses ambient air, and the recirculated air is added to the fresh (undepleted) air being supplied to the cathode downstream of the pump. In order to compensate for pressure drops occurring across the fuel cell cathode, the recirculation system includes an additional recirculation pump.

U.S. Pat. No. 6,015,634 describes a similar design. Here as well, air is supplied to the cathode using a compressor and part of the air exiting the cathode is recirculated via a further compressor and a return line to the area of the cathode intake, where it is added to the already compressed incoming fresh air for the cathode.

The designs described in the two mentioned publications make it possible to achieve a water balance of the overall system, since in each design some water is recirculated through the recirculation lines and thus can be used to humidify the membrane. However, one serious disadvantage of both these designs is that they require an additional component, i.e., the supplemental fan, pump or compressor, in order to maintain the recirculation. Moreover, controlling the recirculated volume is not simple.

U.S. Pat. No. 4,362,789 describes a further design, which illustrates the recirculation of cathode air or other oxidant exhaust stream in a fuel cell. Here as well, recirculation of the oxidant is implemented so that the recirculated oxidant is added to the fresh oxidant being supplied to the cathode, between the compressor and the cathode chamber. A jet pump is provided to compensate for the pressure drop across the cathode.

### BRIEF SUMMARY OF THE INVENTION

In one aspect, the present methods and apparatus for supplying an oxidant, such as air, to a cathode of a fuel cell, simplify the above-mentioned designs and operate with a reduced complexity of components, and open-loop and/or closed-loop control. This is accomplished by employing an oxidant supply device and recirculating part of the oxidant discharged from the cathode into the fresh oxidant stream supplied to the cathode, upstream of the oxidant supply device, via a throttle device.

The fact that the recirculated oxidant enters the oxidant supply stream upstream of the device used to compress the oxidant supply stream has several advantages that more than compensate for the slightly higher expenditure of energy necessary to enable the oxidant supply device to supply a greater volume of oxidant to the cathode.

One advantage is that a humidifier is not necessary for operation of the system, and thus may be eliminated. In this aspect, humidification is accomplished through the recirculation of the moist cathode exhaust into the incoming oxidant supplied to the cathode. The cathode exhaust is moist due to the product water that is produced at the cathode through the conversion of oxygen and hydrogen to electrical energy and water. Although little or no moisture will be available during the start-up phase, humidification is less critical during that phase. Generally, the fuel cell can be started more rapidly without humidification.

In addition, due to the larger quantity of gas passing across the cathode for a given operating stoichiometry (due to the recirculation of an oxygen-depleted oxidant stream), more water vapour can be absorbed and more liquid water can be carried off in the cathode exhaust, so that overall, more water vapour can be discharged from the cathode. This can enhance fuel cell performance, which is a further significant advantage.

As the recirculated stream has a very high water vapour and possibly liquid water content, liquid water may be present in the recirculation stream downstream of the throttle device and will be carried by the recirculated gas. This liquid water then enters the oxidant supply device. This is another advantage since in various compressor designs, injecting water into the compressor can significantly increase compressor efficiency.

Due to the moisture—partially present as liquid—that is recirculated to the compressor, energy generated during compression can be used to evaporate the liquid water, either completely eliminating the need for a cooler, such as a charge-air cooler, between the compressor and the cathode, or reducing the cooler's required cooling capacity, which in turn saves space and costs.

In another aspect, the throttle device is controllable so that it can influence the ratio of oxidant exhaust to be recirculated versus released or vented. For example, comparatively simple control of the throttle device can be accomplished by using a variable cross section or similar, which can be used to simply and accurately set the degree of humidification that is effected by the recirculated oxidant.

These and other aspects will be evident upon reference to the attached Figures and following detailed description.

### BRIEF DESCRIPTION OF THE DRAWINGS

FIG. 1 is a schematic representation of one embodiment of the present methods and apparatus.

FIG. 2 is a diagram of power demand and dew point as a function of the oxidant recirculation ratio.

FIG. 3 is a schematic representation of an alternative embodiment of the present methods and apparatus.

FIG. 4 is a schematic representation of a further embodiment of the present methods and apparatus.

### DETAILED DESCRIPTION OF THE INVENTION

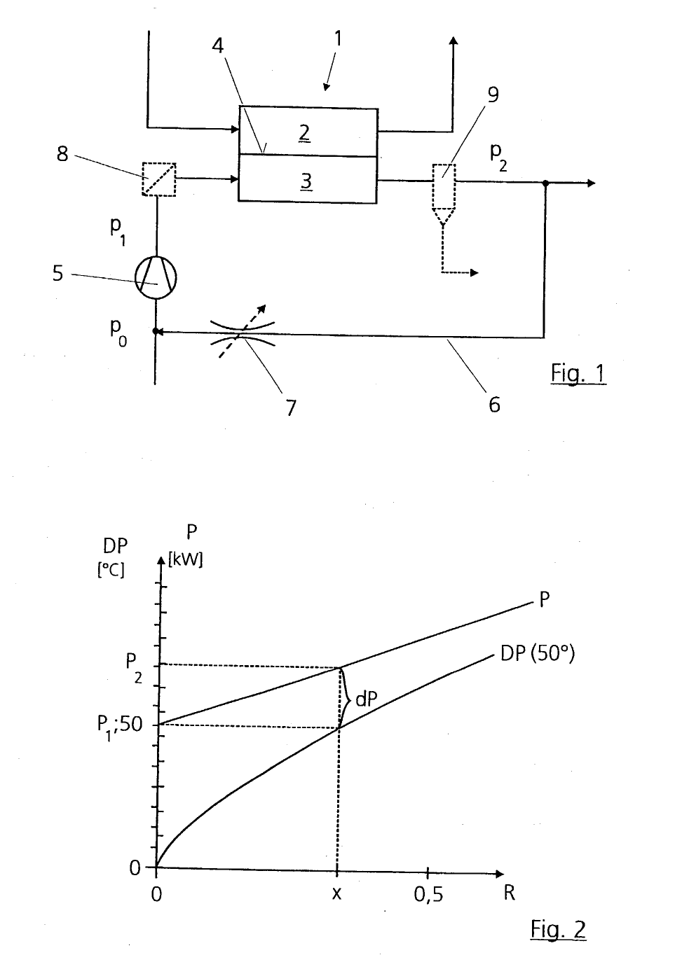

FIG. 1 shows a fuel cell 1 that includes an anode 2 and a cathode 3, which are separated by a proton-conducting membrane 4. In this context, anode 2 and cathode 3 are to be understood either as single chambers in fuel cell 1 or as interconnected chambers in a fuel cell stack.

An oxidant-supply device 5 supplies an oxygen-containing stream (referred to herein as the “oxidant stream”), such as air, to cathode 3. Oxidant-supply device 5 is used to raise the pressure of ambient air from the ambient air pressure p₀ to the working pressure p₁ of fuel cell 1 and to heat the air to the intake temperature T₁ in the area of cathode 3. After passing through cathode 3, this pressure will be reduced to p₂ due to the pressure drop across cathode 3. After passing through cathode 3, the oxidant stream will be at a temperature T₂, which in a typical fuel cell stack is generally approximately 5-15 K higher than temperature T₁. After passing though cathode 3, the oxidant stream will comprise air partially depleted of oxygen and both gaseous and liquid product water. Subsequently, a portion of the oxidant stream is released to the surroundings. Further components (not shown), such as condensers, coolers, and similar devices may be used to separate water from the stream discharged. The remainder of the oxidant stream exiting cathode 3 is recirculated through a return line 6 where it re-enters the oxidant stream supply piping upstream of oxidant supply device 5.

Within return line 6, the pressure of the recirculated oxidant stream is reduced from pressure p₂ to ambient pressure p₀ using a throttle device, which may be a controllable throttle 7, as shown in FIG. 1. In addition to reducing the pressure, throttle device 7 makes it possible, for example by means of a variable cross section, to influence the quantity of oxidant stream flowing through return line 6. Thus, throttle device 7 may be used to set the recirculation ratio R, that is, the ratio of the amount of oxidant stream exiting cathode 3 that is released to the surroundings to the amount that is recirculated via return line 6.

FIG. 1 shows two optional components, which are indicated by dashed lines. The first of these components is a cooler 8, situated between oxidant supply device 5 and cathode 3. In conventional systems, a cooler is standard equipment and is comparatively large and complicated. In the depicted embodiment, cooler 8 is not required in principle, but it may be needed under certain load conditions. Even if such an optional cooler 8 is employed, it can possess a significantly lower cooling capacity and thus a significantly smaller footprint than coolers employed in systems without oxidant recirculation upstream of the cooler and oxidant supply device.

The second optional component is a liquid separator 9, which may be located downstream of cathode 3 to separate liquid water from the oxidant exhaust stream.

This may allow for more stable control—via the recirculation ratio set by throttle device 7—of the humidification of cathode 3. In general, however, liquid separator 9 is intended to remove only already condensed excess water from the oxidant stream, allowing it to be very small and simple.

FIG. 2 shows a diagram that shows the dew point of the oxidant stream flowing into cathode 3, i.e., air in the illustrated embodiment, as a function of the recirculation ratio R, as well as the power demand P of oxidant supply device 5, also as a function of the recirculation ratio R.

Obviously, the power demand of oxidant supply device 5 is higher with recirculation (R>0) than without (R=0), due to the expansion of the recirculated oxidant stream from higher pressure p₂ to ambient pressure p₀ and the subsequent need for recompression of a greater volume of air to p₁ by oxidant supply device 5.

FIG. 2 is based on a system operated with the oxidant stream entering cathode 3 at its dew point (DP), at a hypothetical temperature of 50° C. and at an approximately constant pressure p₁. The lower curve shows the behaviour of the dew point (at 50° C.) as a function of the recirculation ratio R.

Where no recirculation is present, i.e., R=0, the stream is at the dew point at the hypothetical 50° C. and pressure p₁, the corresponding compressor power demand is P₁. A humidifying device, such as a membrane humidifier or similar device, would be necessary to provide moisture to the oxidant stream so it has a dew point of 50° C.

If the recirculation ratio R is increased, the dew point will increase along the solid line. The desired dew point at 50° C. will be achieved at a recirculation ratio of x. The recirculation ratio R=x is typically in a range of approximately 0.25 to 0.3, i.e., a recirculation of 25 to 30% of the cathode exhaust stream.

However, at a recirculation ratio R=x, the required compressor power demand is P₂. Thus, eliminating the humidifier completely and realizing ideal humidification of the cathode 3 with a simple oxidant recirculation control scheme requires additional power, dP=P₂−P₁.

In order to keep the energy required as low as possible, it may be desirable to operate the fuel cell at comparatively low operating pressures p₁, p₂, since this means that comparatively low compressor power is required. Thus, in one embodiment, if the inlet pressure p₁ upstream of cathode 3 is in a range below 3 bar absolute, throttle device 7 may be adjustable, and thus the pressure difference to be generated by oxidant supply device 5 is ≦2 bar. These considerations may be taken further, and accordingly in another embodiment, the system can be configured to operate with a very low intake pressure p₁, such as 1.6 to 1.8 bar absolute pressure.

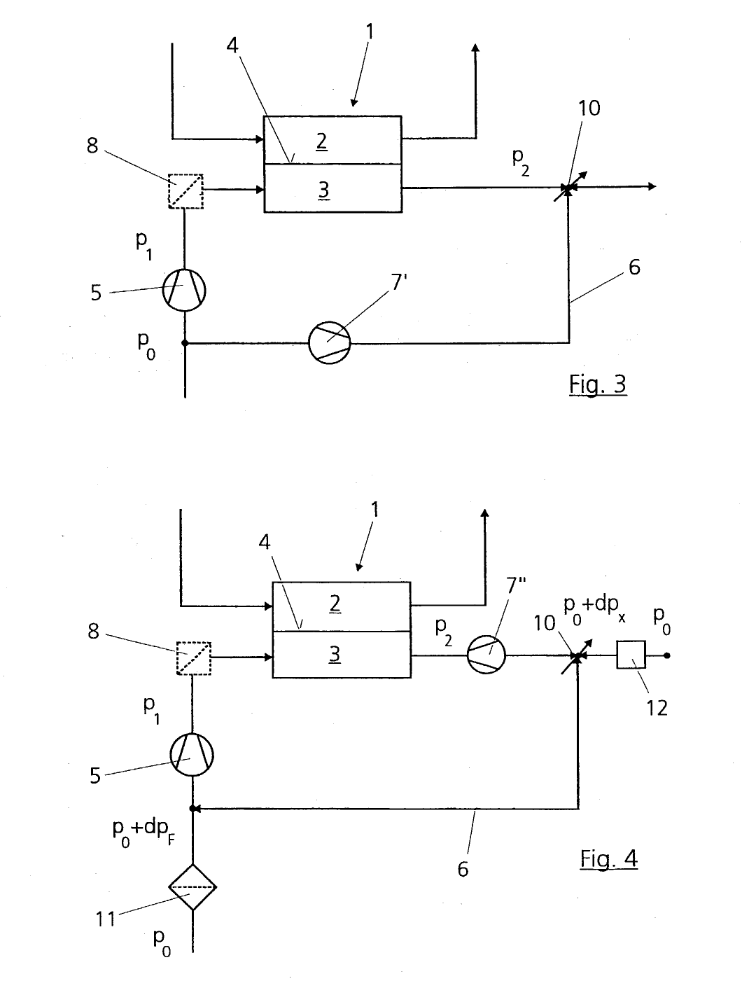

FIG. 3 and FIG. 4 illustrate two further embodiments, which are especially suitable for higher pressures, i.e., where pressure p₁ is at least 3 bar.

The apparatus shown in FIG. 3 is very similar to that of FIG. 1, except that it uses an expander 7′ as a throttle device instead of controllable throttle 7. In principle, expander 7′ may be, for example, a turbine. The shown embodiment also includes a controllable valve 10, for example a proportional valve, to set the proportion of oxidant that is recirculated, i.e., the recirculation ratio R. Apart from this, the arrangement is comparable to that in FIG. 1, except that the energy obtained during the expansion in return line 6 can be used to either contribute to the driving of oxidant supply device 5—with the help of appropriate energy converters—or to provide energy that can then be utilized elsewhere.

FIG. 4 illustrates a further alternative embodiment. Since expanders are commonly used in the exhaust gas lines from anode 2 and cathode 3, the expander may be configured so that the entire exhaust gas stream, which leaves cathode 3 at a pressure p₂, flows through the expander 7″ and at least partially releases its energy, which can then be made available elsewhere.

FIG. 4 also shows further components, such as a filter 11 in the intake air line. (Although not previously illustrated as such, filter 11 may optionally be used with any of the embodiments of the present methods and apparatus.) Also shown in FIG. 4 are additional components 12 in the exhaust gas discharge system, such as an exhaust gas purification device. For the purposes of the following discussion, only the pressure drops generated by filter 11 and additional components 12 are relevant, not their actual arrangement or composition. In the following discussion, the pressure drop across filter 11 is referred to as dp_{f}, while the pressure drop produced by the additional components 12 is referred to as dpₓ.

FIG. 4 is provided to show that even for this type of arrangement, with an expander 7″ immediately downstream of cathode 3, an additional delivery device in return line 6 is not necessary. The pressures set out in the following discussion are purely for discussion only their sole purpose is to explain the mode of operation of the schematically illustrated embodiment.

For example, assuming an ambient pressure p₀ of 1 bar, a pressure drop dp_{f} of approximately 50 mbar might occur across filter 11. Thus, downstream of filter 11, the pressure will be p₀−dp_{f}=950 mbar.

Oxidant supply device 5 compresses the oxidant stream upstream of cathode 3 from this pressure to a pressure p₁, for example 3.5 bar. After flowing through cathode 3, which will also create a pressure drop, the oxidant stream might be at a pressure p₂ of approximately 3.2 bar. Expander 7″ will adjust this pressure so as to enable the discharged stream to flow through the additional components 12. Assuming a pressure drop dpₓ of approximately 100 mbar across the additional components 12, this results in a pressure drop of dpₓ+dp_{f}, i.e., approximately 150 mbar, between the intersection of return line 6 and valve 10 and the area upstream of oxidant supply device 5, which allows a return flow to the degree set by valve 10.

Thus, the present methods and apparatus may also be used in a system that operates with higher pressures, whereby it may be intended that energy is recovered by expanders 7′ or 7″ to improve the energy balance.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. An oxidant supply system for a fuel cell, comprising:
an oxidant supply device disposed in an oxidant supply line to supply an oxidant stream to a cathode of the fuel cell;
an oxidant return line to receive and recirculate at least a portion of an oxidant exhaust stream from the cathode; and
a throttle device disposed in the return line;
wherein the return line is connected to the oxidant supply line upstream of the oxidant supply device.

2. The oxidant supply system of claim 1, further comprising a discharge valve located downstream of the fuel cell for discharging at least a portion of the oxidant exhaust stream.

3. The oxidant supply system of claim 2, wherein the throttle device is disposed upstream of the discharge valve.

4. The oxidant supply system of claim 2, wherein the throttle device is disposed downstream of the discharge valve.

5. The oxidant supply system of claim 2, wherein a ratio of the recirculated portion of the oxidant exhaust stream to the discharged portion of the oxidant exhaust stream is controlled using the throttle device.

6. The oxidant supply system of claim 1, further comprising a liquid separator disposed upstream of the throttle device.

7. The oxidant supply system of claim 1, wherein the throttle device comprises an expander.

8. A method of supplying oxidant to a fuel cell, comprising supplying a fresh oxidant stream to a fuel cell oxidant inlet via an oxidant supply device and recirculating at least a portion of an oxidant exhaust stream from a fuel cell oxidant outlet to the fuel cell oxidant inlet, wherein the recirculated portion of the oxidant exhaust stream is introduced into the fresh oxidant stream upstream of the oxidant supply device.

9. The method of claim 8, wherein the recirculated portion of the oxidant exhaust stream is recirculated via a throttle device.

10. The method of claim 8, wherein at least a second portion of the oxidant exhaust stream is discharged.

11. The method of claim 10, wherein a ratio of the recirculated portion of the oxidant exhaust stream to the second portion of the oxidant exhaust stream is controlled by adjusting the throttle device.

12. The method of claim 8, wherein a pressure increase provided by the oxidant supply device is less than about 2 bar.
